(19) United States
(12) Patent Application Publication
(10) Pub. No.: US 2016/0282132 A1
(43) Pub. Date: Sep. 29, 2016

(54) PREDICTIVE NAVIGATION

(71) Applicant: International Business Machines Corporation, Armonk, NY (US)

(72) Inventors: James E. Bostick, Cedar Park, TX (US); Hernan A. Cunico, JR., Holly Springs, NC (US); John M. Ganci, JR., Cary, NC (US); Martin G. Keen, Cary, NC (US)

(21) Appl. No.: 14/670,701

(22) Filed: Mar. 27, 2015

(51) Int. Cl. G01C 21/34; G08G 1/01; H04L 12/58

(52) U.S. Cl. CPC G01C 21/3415; H04L 51/046; G08G 1/01

(57) ABSTRACT

A method, computer system and computer program product for predicting traffic is provided. A processor determines a content of a first message posted to a social network, determines that the content of the first message describes a first event, determines an amount of predicted traffic to be caused by the first event, determines a content of a second message posted to a social network, determines that the content of the second message describes the first event, and adjusts the amount of predicted traffic to be caused by the first event based, at least in part, on the content of the first and second message.

### BACKGROUND OF THE INVENTION

The present invention relates generally to the field of navigation, and more particularly to predicting traffic events.

Navigation devices have become essential tools in travel. Either as embedded devices in vehicles or as applications on hand held devices, users rely on such tools to aid in finding a route to a destination. Navigation devices typically store models for a network of roads, or in other cases download the road network from a server, thereby removing the need of the user to have a map on hand to figure out a route to drive. A major obstacle when traveling along the road network is congestion or traffic caused by other people on the roads.

### SUMMARY

Embodiments of the present invention provide a method, system, and program product to determine a content of a first message posted to a social network, determine that the content of the first message describes a first event, determine an amount of predicted traffic to be caused by the first event, determine a content of a second message posted to a social network, determine that the content of the second message describes the first event, and adjust the amount of predicted traffic to be caused by the first event based, at least in part, on the content of the first and second message.

### BRIEF DESCRIPTION OF THE SEVERAL VIEWS OF THE DRAWINGS

FIG. 1 is a functional block diagram illustrating a predictive navigation environment, in accordance with an exemplary embodiment of the present invention.

FIG. 2 illustrates operational processes of a traffic prediction program, on a computing device within the environment of FIG. 1, in accordance with an exemplary embodiment of the present invention.

FIG. 3 illustrates operational processes of a navigation program, on a computing device within the environment of FIG. 1, in accordance with an exemplary embodiment of the present invention.

FIG. 4 illustrates an example road network with a route, predicted traffic and alternative route, in accordance with an exemplary embodiment of the present invention.

FIG. 5 depicts a block diagram of components of the computing device executing the operational processes of FIGS. 2 and 3, in accordance with an exemplary embodiment of the present invention.

### DETAILED DESCRIPTION

While solutions for determining a route for a vehicle are known, they rely on information describing past events. Such solutions do not take into consideration how the traffic conditions will be when a user arrives at a particular destination or location along the route. When a user leaves their house, traffic across town may be clear. However, by the time the reach the other side of the town, heavy traffic has made the current route undesirable. Embodiments of the present invention recognize that by collecting certain information and determining the contents of said information, future traffic events are determined thus allowing a user to find alternative routes in order to avoid the future traffic events. Information sources, such as social media messages, news articles and other information describing events, are analyzed to determine future traffic events and their impact. Embodiments of the present invention provide identification of future traffic events and alternative routes to avoid the traffic said events produce.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

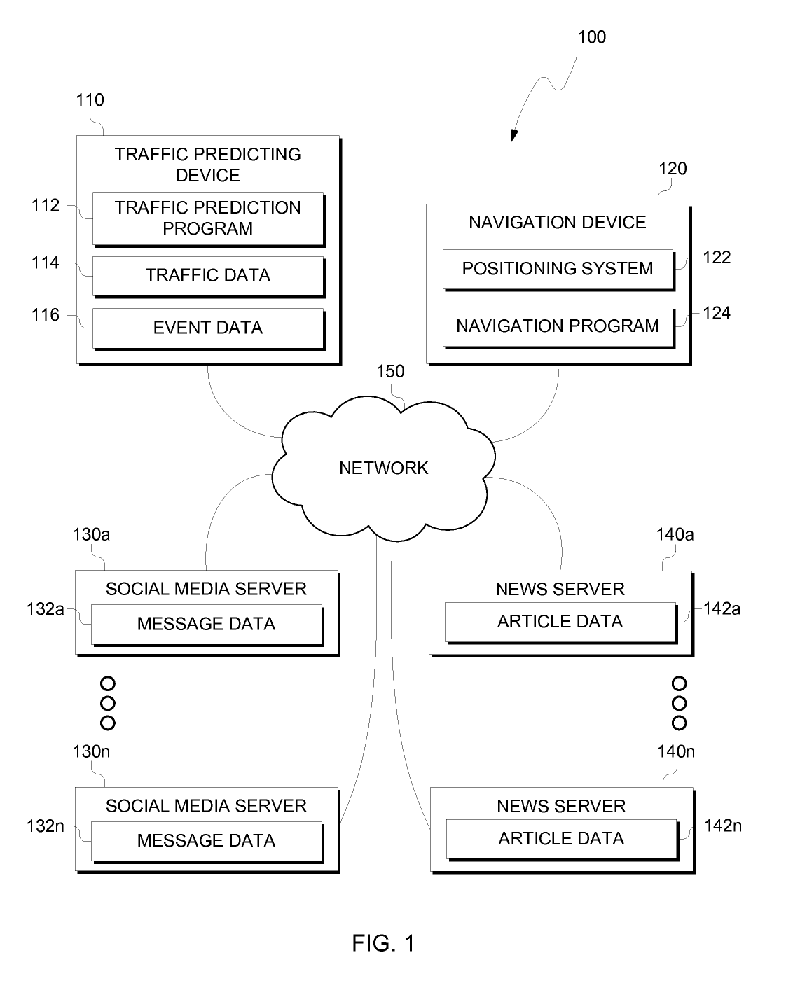

The present invention will now be described in detail with reference to the Figures. FIG. 1 is a functional block diagram illustrating predictive navigation environment, generally designated 100, in accordance with one embodiment of the present invention. Predictive navigation environment 100 includes traffic predicting device 110, navigation device 120, one or more social media servers 130a-n (collectively 130) and one or more news servers 140a-n (collectively 140) connected over network 150. Traffic predicting device 110 includes traffic predication program 112, traffic data 114 and event data 116. Navigation device 120 includes positioning system 122 and navigation program 124. Social media databases 130a-n include, respectively, message data 132a-n (collectively 132). News servers 140a-n include, respectively, article data 142a-n (collectively 142).

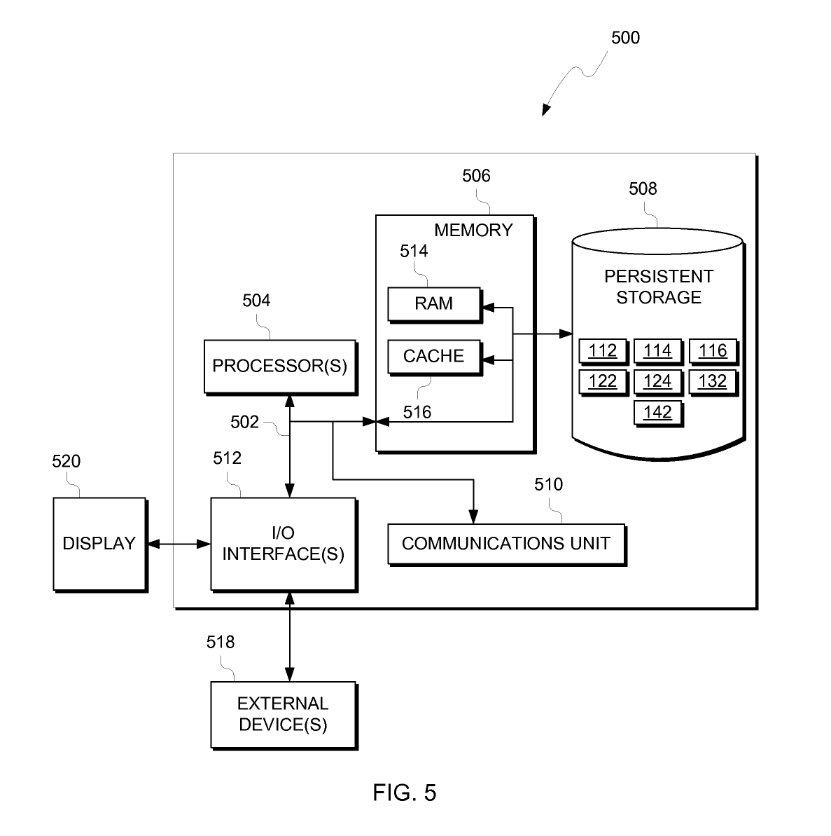

In various embodiments of the present invention, traffic predicting device 110, navigation device 120, social media servers 130 and news servers 140 are each a computing device that can be a standalone device, a server, a laptop computer, a tablet computer, a netbook computer, a personal computer (PC), or a desktop computer. In another embodiment, traffic predicting device 110, navigation device 120, social media servers 130 and news servers 140 each represent a computing system utilizing clustered computers and components to act as a single pool of seamless resources. In general, traffic predicting device 110, navigation device 120, social media servers 130 and news servers 140 can be any computing device or a combination of devices with access to traffic data 114, event data 116, positioning system 122, message data 132 and article data 142 and is capable of executing traffic predication program 112 and navigation program 124. Traffic predicting device 110, navigation device 120, social media servers 130 and news servers 140 may each include internal and external hardware components, as depicted and described in further detail with respect to FIG. 5.

In this exemplary embodiment, traffic predication program 112, traffic data 114 and event data 116 are stored on traffic predicting device 110; positioning system 122 and navigation program 124 are stored on navigation device 120; message data 132 is stored on social media server 130; and article data 142 is stored on news servers 140. However, in other embodiments, traffic predication program 112, traffic data 114, event data 116, positioning system 122, navigation program 124, message data 132 and article data 142 may be stored externally and accessed through a communication network, such as network 150. Network 150 can be, for example, a local area network (LAN), a wide area network (WAN) such as the Internet, or a combination of the two, and may include wired, wireless, fiber optic or any other connection known in the art. In general, network 150 can be any combination of connections and protocols that will support communications between traffic predicting device 110, navigation device 120, social media server 130 and news servers 140, in accordance with a desired embodiment of the present invention.

In various embodiments, traffic prediction program 112 determines traffic for a network of roads. Traffic prediction program 112 stores traffic for a network of roads in traffic data 114. Traffic data 114 includes entries for roads for a given area or location (e.g., a city, state or country). In some embodiments, traffic data 114 includes segments of a road where the road is broken into smaller parts. For example, a road is segmented based on intersections with other roads of the network. As another example, a road is segmented into one or more units of distance (e.g., every quarter mile or one hundred feet). In various embodiments, traffic prediction program 112 assigns each road or segment an amount of traffic. For example, a road or segment is assigned a category representative of the amount of traffic (e.g., light, medium, or heavy). As another example, a road or segment is assigned an amount of traffic (e.g., ten cars per minute pass through the road or segment). In various embodiments, traffic data 114 includes the amount of traffic for each road or segment for one or more time periods. As discussed herein, traffic prediction program 112 determines amount of traffic for a road or segment for multiple time periods. For example, traffic data 114 includes current amount of traffic for a road or segment and a predicted amount of traffic for that segment at a future point in time.

In various embodiments, traffic data 114 includes the amount of traffic for one or more previous time periods, a current time period or future time periods. In some embodiments, the time periods cover a span of time (e.g., ten minute intervals). In other embodiments, the time periods are specific points in time (e.g., twenty minutes in the past, traffic at the current time, predicted traffic ten minutes in the future and predicted traffic thirty minutes in the future). In various embodiments, traffic prediction program 112 receives current and past amounts of traffic observed from various sources (not shown). For example, sources of current and past amount of traffic include, but are not limited to, sensors part of the road network, government entities (e.g., departments of transportation) or crowd sourced data describing the amount of traffic. In some embodiments, traffic prediction program 112 stores both predicted amounts of traffic and observed amounts of traffic in traffic data 114 as time progresses. Traffic prediction program 112 retains predicted amounts of traffic to train prediction processes. By comparing the predicted amount to observed amounts, traffic prediction program 112 alters the prediction processes to provide predictions with an increased degree of accuracy when predicting traffic impediment.

In various embodiments, traffic prediction program 112 determines current or future events co-located with the network of roads represented in traffic data 114. Traffic prediction program 112 stores a variety of events, and a respective traffic impact of each event, in event data 116. Traffic prediction program 112 determines current or future events co-located with the network of roads based on respective message data 132a-n (collectively 132) of one or more social media servers 130a-n (collectively 130). Traffic prediction program 112 sends a request for message data 132 posted on a social media server 130. For example, traffic prediction message 112 includes an application programming interface (API) to interface with social media server 130. The API defines operations to retrieve messages made by users of social media server 130. Additionally, the API provides operations to retrieve metadata related to a message which includes, but not limited to, the location the message was made, the time the location was made, and groups or listing of users the message was directed to.

In various embodiments, traffic prediction program 112 analyzes each message from message data 132 to determine the content of the message. For example, traffic prediction program 112 performs Natural Language Processing (NLP) to determine the content of the message. Traffic prediction program 112 determines if a message is related to an event that is currently occurring or will occur sometime in the future. Example events include, but are not limited to, concerts, public speeches, sports' exhibitions or games, or any other type of public gathering. Other types of events determined from messages posted to social media servers 130 also include observations or descriptions of events that may impact traffic, such as weather or accidents.

In various embodiments, traffic prediction program 112 determines the type of event (e.g., a concert) in addition to a specific instance of the event (e.g., a band or group playing at the concert) contained in a message of message data 132. In addition, traffic prediction program 112 determines a time and location that the event contained in the message has or will occur. In some embodiments, traffic prediction program 112 retrieves metadata regarding the message to determine the time and location. In other embodiments, traffic prediction program 112 analyzes the contents of the message to determine a time or location. For example, a user posts a message “going to see a speech by John Doe this afternoon”. Traffic prediction program 112 determines that an event of a speech is present in the message with the specific instance that the speech is given by John Doe. In addition, traffic prediction program 112 determines that the event will happen in the future (i.e., this afternoon). In further embodiments, traffic prediction program 112 analyzes both metadata of a message and contents of the message to determine the event described by the message. For example, a user posts a message “There was a wreck at 1st and main”. Traffic prediction program 112 determines that the message describes an event of a wreck that happened at the intersection of First St. and Main St. Traffic prediction program 112 determines the intersection is a common entry in the road network (e.g., multiple cities have a similar intersection). Traffic prediction program 112 retrieves metadata of the message to determine where the user was when the message was posted. In the above example, the user has posted the message after observing a wreck and is not currently at the wrecks location. Traffic prediction program 112 determines the location of the event, through NLP of the content of the message, in addition to the location the user is at when the message is posted, through metadata of the message. Traffic prediction program 112 determines the closest matching intersection to the location the message was posted at to determine the location of the event (i.e., the wreck).

In various embodiments, traffic prediction program 112 determines an impact on traffic a determined event from message data 132 currently has or will have. In some embodiments, traffic prediction program 112 determines the impact on traffic based on the content of a message in message data 132 and sentiment analysis of the same message in message data 132. Sentiment analysis determines subjective information or opinions contained in a message. For example, a message states “Just saw a bad wreck on Oak Ave”. Traffic prediction program 112 determines objective information describing the event (i.e. a wreck) and the event location (i.e., Oak Ave.). Furthermore, traffic prediction program 112 determines the subjective information of the message (e.g., the wreck is severe based on the modifying term “bad”). As another example, a message states “Fender-bender just happened outside my house”. Traffic prediction program 112 determines objective information describing the event (i.e. a wreck) and the event location (i.e., via metadata a user's home location is determined and the nearest road is selected). Furthermore, traffic prediction program 112 determines the subjective information of the message (e.g., the wreck is of a type “minimal” due to the phrase fender-bender being a type of wreck with less severe implications than a typical wreck).

In some embodiments, traffic prediction program 112 determines the amount of traffic an event has caused or will cause based on the frequency of the event in message data 132. If traffic prediction program 112 determines that only one message indicates an event, then traffic prediction program 112 determines that the traffic associated with the event is low. If traffic prediction program 112 determines a larger amount of messages describe the same event, then traffic prediction program 112 determines that the traffic associated with the event is high. For example, if only a few messages in message data 132 describe a car crash, then traffic prediction program 112 determines the crash does not have a large impact. Conversely, if a large number of messages in message data 132 describe an event, then traffic prediction program 112 determines the crash has a larger impact on traffic. An event type (e.g., car accident or crashes) is associated with a predetermined amount of traffic. As the frequency of an event increases in message data 132, traffic prediction program 112 increase the traffic for the instance of the event as more messages describe the event.

In other embodiments, traffic prediction program 112 determines a confidence score an event has or will have an impact on traffic based on the frequency of the event in message data 132. For example, if traffic prediction program 112 determines only a one messages indicates an event, then traffic prediction program 112 assigns a low confidence score to the event. If traffic prediction program 112 determines a larger amount of messages indicates an event, then traffic prediction program 112 assigns a high confidence score to the event. In some embodiments, traffic prediction program 112 determines a confidence score based on the author or user of the message. For example, if the message comes from a user who is a trusted source (e.g., a social media account of a police department), then traffic prediction program 112 assigns a higher confidence score, even though the message frequency from other users is low.

In various embodiments, traffic prediction program 112 assigns different impacts or impediments on traffic for the location affected by an event. Example impacts may include, but are not limited to, one or more of an area of effect for the traffic impact, additional travel time, or a time the event will impact traffic. Events with larger impact may cover larger areas of the road network as congestion spread throughout the road network, as such traffic prediction program 112 assigns a larger area of effect to the traffic impact of the event. Events with larger impacts may increase the total traffic on one or more segments of a road network as the event is underway, as such traffic prediction program 112 increases the amount of travel time due to the additional traffic an event causes. Events with larger impacts may take longer to dissipate as traffic leaves the impact area and returns to normal levels, as such traffic prediction program 112 assigns a larger time is to the traffic impact of the event.

In various embodiments, traffic prediction program 112 determines events co-located with a road network based on article data 142 stored on news servers 140. Article data 142 includes, but is not limited to, news articles, press releases, weather reports, or weather advisories or warnings. Traffic prediction program 112 retrieves article data 142 from one or more news servers 140. Traffic prediction program 112 determines the content of an article by applying NLP to the text of the article. Traffic prediction program 112 determines events described within article data 142 in addition to the time and location the event occurs. For example, a weather warning describes an incoming snowstorm for an area including the expected arrival and dissipation of the storm for the area. Traffic prediction program 112 creates an event in event data 116 for the area indicated in the weather warning with a start and end time based on arrival and dissipation of the snowstorm.

In some embodiments, article data 142 includes audio or video portions. Traffic prediction program 112 performs voice recognition to the audio or video portions of article data 142 to create a transcript of the audio or video. Traffic prediction program 112 applies NLP to the transcript to determine the content of the audio or video portions of article data 142. For example, article data 142 includes a streaming audio source of a radio station's broadcast. A part of the broadcast includes a traffic report at a scheduled time. Traffic prediction program 112 retrieves the portion of the broadcast including the traffic report at the scheduled time. After performing voice recognition to the traffic report, traffic prediction program 112 determines the content of the traffic report based on a NLP on a transcript of the radio broadcast of the traffic report.

In various embodiments, traffic prediction program 112 determines events based on both message data 132 and article data 142. For example, a news article in article data 142 describes a sports game that will be hosted at a local stadium. The article includes a start time for the game, however does not include an end time since the game may take longer than expected (e.g., overtime or commercial breaks prolong the game). Traffic prediction program 112 estimates an end time for the event based on past events of the same type (e.g., football games last a predetermined amount of time). At a later time, traffic prediction program 112 determines that some social messages in message data 132 state that the game is almost over (e.g., “Team A just won the game”). Traffic prediction program 112 updates the end time for the event in event data to reflect the time the messages were posted to the respective social media server 130 the message was retrieved from. As another example, traffic prediction program 112 assigns a reliability score to message data 132 and article data 142. The reliability score indicates the trustworthiness of a source (e.g., the author of a message or article). A message or article from a news agency or a government entity may be given a higher reliability score than that of an unknown or unverified source. In cases where a conflict between message data 132 or article data 142 from different sources arises (e.g., a weather report predicts inclement weather and a social media message says the roads are clear), traffic prediction program 112 selects the source with the higher reliability score for creating or updating an event in event data 116.

In various embodiments, traffic prediction program 112 updates traffic data 114 for roads based on events in event data 116. Based on the location of the event, traffic prediction program 112 updates traffic data 114 for roads co-located in the area surrounding the event. Traffic prediction program 112 determines the time frame that an event will impact traffic and updates the amount of traffic caused by the event for the respective time in traffic data 114. For impacted roads, traffic prediction program 112 updates traffic data 114 with the additional amount of travel time the impact of the respective events. For example, traffic data 114 for a road has a one minute additional travel time due to light traffic. Traffic prediction program 112 determines an event in event data 116 will create additional traffic in one hour, causing additional travel time of ten minutes when driving along the road. Traffic prediction program 112 updates the predicted traffic data 116 one hour from the current time by combining the preexisting one minute traffic and the additional traffic caused by an event, resulting in an updated traffic data 116 for the road of eleven minutes additional travel time.

In various embodiments, traffic prediction program 112 determines the traffic impact of an event based on one or more external factors of the event. For example, traffic prediction program 112 determines the date or time an event occurs and adjusts the amount of predicted traffic for the event. In one embodiment, a sports event that occurs early in the season will have less attendance than later games in the same season. As such, traffic prediction program 112 may lower the amount of traffic predicted to be caused by a sports event that takes place early in the season. In another embodiment, traffic prediction program 112 retrieves the current season's win and loss record, for example through article data 142, for teams participating in a sports event. Traffic prediction program 112 may increase the amount of traffic for teams participating in the event that are having a successful season (e.g., a high win/loss ratio). Furthermore, traffic prediction program 112 may determine that a specific instance of an event is more popular and therefore will have a larger traffic impact. For example, a playoff game for a sports event is more popular than a normal season game and, therefore, traffic predication program 112 predicts a larger amount of traffic for playoff games.

In various embodiments, traffic prediction program 112 determines an additional travel time for multiple events predicted to impact traffic for a given road at a given time. In some embodiments, traffic prediction program 112 combines the traffic impact of the both events by adding the additional travel times predicted for each event. For example, traffic prediction program 112 determines inclement weather will cause fifteen minutes additional travel time. Also traffic prediction program 112 determines a concert ending soon will cause five minutes additional travel time. Traffic prediction program 112 determines that in two hours both event will impact traffic on a road. Traffic prediction program 112 determines the total additional travel time to be twenty minutes by adding the travel time for both events.

In various embodiments, traffic prediction program 112 performs a self-learning algorithm to determine the accuracy of a predicted traffic impact for an event. After a prediction made by traffic prediction program 122 for a traffic impact of an event, traffic prediction program 112 compares the predicted traffic impact with data gathered from one or more traffic reporting services (not shown) for the time and location the event was predicted to occur. Based on the comparison, traffic prediction program 112 adjusts later predictions for similar events that match the event for which a traffic impact was predicted. For example, traffic prediction program 122 determines that a “concert ending” event at a certain location will cause a ten minute delay for a road. At a later time, traffic prediction program 112 receives the actual traffic caused by the event and determines the delay caused by the event was fifteen minutes. Traffic prediction program 112 assigns a new traffic impact to traffic predictions made with for similar events (e.g., concerts ending at the same location) to account for the error in the prediction. Traffic prediction program 112 determines a difference between the predicted traffic impact and the observed traffic impact. If the determined difference between traffic impacts is not significant, then traffic prediction program 112 continues to base later predictions on the predicted traffic impact. For example, if the predicted and the observed traffic impact differs by only a minute, then traffic prediction program 112 does not adjust the predicted impact for later similar events. If the determined difference is significant, then traffic prediction program 112 adjusts adjust the predicted impact for later similar events. In some embodiments, traffic prediction program 112 adjusts later prediction for similar events based on the observed traffic received from the one or more traffic reporting services. Using the above example, later predictions are now based on fifteen minutes for predictions of traffic impact for similar events. In other embodiments, traffic prediction program 112 adjusts later prediction for similar events on a amount between the predicted traffic impact and the observed traffic impact received from the one or more traffic reporting services. Using the above example again, traffic predication program 112 now bases predictions for similar events between ten and fifteen minutes, for example a mean of the two numbers (i.e. 12.5 minutes).

In other embodiments, traffic prediction program 112 performs a self learning algorithm to determine the traffic impact a combination of events will have on traffic. After a prediction on a combination of events is made, traffic prediction program 112 compares the predicted traffic impact with data gathered from traffic reporting services (not shown) for the time the events where predicted to both occur. Based on the comparison, traffic prediction program 112 adjusts later predictions for combinations of similar events to match the difference between the predicted traffic impact and the actual traffic impact. For example, traffic prediction program 112 determines two events that will impact traffic will both occur at the same time. Traffic prediction program 112 determines an additional travel time to be twenty minutes (e.g., one event is predicted to cause fifteen minutes of additional travel time and a second event is predicted to cause five minutes of additional travel time). However, traffic prediction program 112 collects data describing the actual traffic impact during the time both events occurred to have caused thirty minutes of additional travel time. Traffic prediction program 112 creates an adjustment factor for the two events. Traffic prediction program 112 uses the adjustment factor to alter the combined time to reflect the traffic impact of both events occurring at the same time will have. In this example, the previously predicted impact of twenty minutes was later observed to be thirty minutes. Traffic prediction program 112 determines an adjustment factor of 150% when both event occur. When making predictions, traffic prediction program 112 includes the adjustment factor to reflect the additional travel time the combination of both events have on traffic.

In various embodiments, navigation device 120 provides navigation across a road network for a user. Navigation device 120 includes a positioning system 122 to determine the current location of the device. In some embodiments, positioning system 122 includes a Global Positioning System (GPS) receiver to determine the location of navigation device 120. In other embodiments, positioning system 122 determines the location of navigation device 120 by location based services provided by a cellular network. In an embodiment, positioning system 122 determines the location of navigation device 120 by a combination of GPS and location based services. In various embodiments, navigation device 120 includes navigation program 124. Navigation program 124 receives a destination from a user to determine a route to navigate a road network. Navigation program 124 determines a route from the current location of the navigation device to arrive at the received destination. In some embodiments, navigation program 124 determines a route by selecting a route with the shortest distance. In other embodiments, navigation program 124 determines a route by selecting a route with the shortest travel time.

In various embodiments, navigation program 124 receives traffic data 114 stored on traffic prediction device 110. Navigation program 124 determines if traffic data 114 includes traffic for roads or road segments that the currently determined route passes through to reach the received destination. As navigation program 124 analyzes the determined route, an estimated time is determined which indicates when the user will arrive to a corresponding location along the determined route to reach the received destination. For traffic predicted to be present along the determined route, navigation program 124 determines if the travel time will be increased for traveling through the one or more roads or road segments of the determined route. In some embodiments, any predicted traffic causing increased travel time is considered to have a traffic impact on the determined route. In other embodiments, only increased travel time that exceeds a certain amount due to predicted traffic is considered to have a traffic impact on the determined route. For example, if a particular road has a minimal amount of additional travel time (e.g., one minute) then the traffic impact caused by one or more events is not sent to navigation device 124. In various embodiments, navigation program 124 receives the corresponding event data 116 for traffic events that will impact the travel along the determined route. Navigation program 124 displays a view of the road network with the currently determined route overlaid on the network. In some embodiments, navigation program 124 also displays areas of impact for traffic events overlaid on the network. In other embodiments, navigation program 124 highlights the roads affected by traffic events.

In various embodiments, navigation program 124 determines an alternative route when a location along the route intersects with a traffic event in event data 116. Navigation program 124 compares the travel time of the currently determined route to the travel times of one or more alternative routes. When the total travel time for the alternative route is less than the total travel time of the currently determined route, navigation program 124 selects the alternative route. In some embodiments, navigation program 124 displays the alternative routes to the user. Navigation program 124 receives user input for selecting one of the alternative routes. In response to the selection, navigation program 124 updates the currently determined route to bypass to roads or road segments with the traffic events and instead take the selected alternative route. In other embodiments, navigation program 124 automatically selects an alternative route based on the largest decrease in travel time. Once one or more alternative routes are determined, navigation program 124 selects the alternative route with the smallest travel time. Navigation program 124 updates the currently determined route to bypass to roads or road segments with the traffic events and instead take the selected alternative route.

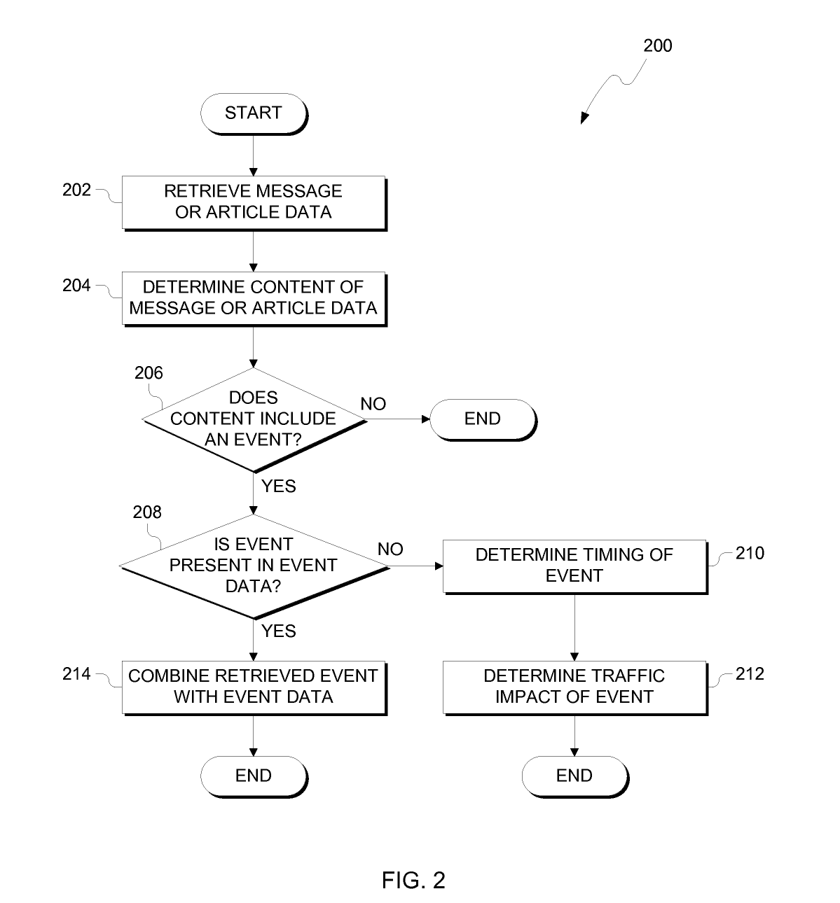

FIG. 2 illustrates operational processes, generally designated 200, of traffic prediction program 112, operating on traffic prediction device 110 within the environment of FIG. 1, in accordance with an exemplary embodiment of the present invention.

In process 202, traffic prediction program 112 retrieves message data 132 or article data 142 from one or more social media servers 130 or news servers 140. In some embodiments, traffic prediction program 112 uses an application programming interface (API) to download messages or articles posted to social media servers 130 or news servers 140. In addition to the data of the messages or articles, traffic prediction program 112 retrieves metadata describing the message or article. For example, metadata includes, but is not limited to, the author of the message or article, the time the message or article was posted or created, or the location of the author when the message or article was posted. In other embodiments, social media servers 130 or news servers 140 are configured to push or upload message data 132 or article data 142 when posted or published to the respective social media servers 130 or news servers 140.

In process 204, traffic prediction program 112 determines the content of message data 132 or article data 142. For message data 132 or article data 142 containing text, traffic prediction program 112 performs natural language processing (NLP) to determine the content of the message. For message data 132 or article data 142 containing audio or video, traffic prediction program 112 performs voice recognition to convert the audio or audio stream of the video to text for analysis. In process 206, traffic prediction program 112 determines if the message or article contains content describing an event. If the content does not describe an event (NO branch of process 206), traffic prediction program 112 discards the message or article. If the content does describe an event (YES branch of process 206), traffic prediction program 112 proceeds with process 208.

Referring back to process 204, in addition to determining the content, traffic prediction program 112 determines one or more of an event type, a specific instance of an event, the location of the event, or the time the event is or will occur. For example, a message in message data 132 states “Arriving at the Company Y Expo”. Traffic prediction program 112 determines the event type to be ‘Exposition’ with the specific instance being an expo for ‘Company Y’. In some cases, multiple event types, such a sports games, may be occurring at similar times. By keeping track of both event types and specific instances of the events, traffic prediction program 112 provides a deeper analysis of the impact each specific event may have on traffic. Referring back to the above example, traffic prediction program 112 also determines the timing of the event from the content of the message. Based on the message and that the author is ‘Arriving’, traffic prediction program 112 determines the timing of the event to be starting. Traffic predication program 112 determines the specific time the user has arrived by retrieving metadata describing when the message was posted. As discussed herein and more specifically in process 214, traffic prediction program 112 combines the determined content of various messages to determine an event and its timing. Based solely on this example message, traffic prediction program 112 determines that the event is starting and ongoing, with a specific start time from metadata about the message. Other messages or articles, either currently posted or posted in the future, may provide an ending timeframe of the event.

In process 208, traffic prediction program 112 determines if the content of a message or article describes matches an event currently stored in event data 116. Traffic prediction program 112 determines that event described in a message or article based on the type and instance of the event (e.g., Concert by Band Z) is occurring at the similar location and time. If the event described in the message or article is not present in event data 116 (NO branch process 208), then traffic prediction program 112 creates an entry for the event. In process 210, traffic prediction program 112 determines a timing of the event. For example, the content of the message contains a time for the event, such as “See you tomorrow at noon before the game”. As another example, the metadata data of a message contains the timing, such as when the message was posted. As another example, traffic prediction program 112 determines the timing from both the metadata and content of a message. A message states “Leaving the concert in an hour”. Traffic prediction program 112 determines the event ends in an hour and bases the time on when the message was posted (e.g., the metadata describing the post) as the time to offset by the hour indicated in the message.

In process 212, traffic prediction program 112 determines a traffic impact for the event. Traffic impacts include, but are not limited to, one or more of an area or set of roads or road segments that the event will cause to have additional traffic, an amount of additional traffic, an amount of additional travel time caused by the additional traffic, or a period of time the additional traffic will be present. In various embodiments, traffic prediction program 112 compares the determined type of event and instance of the event to previous events in event data 116. Based on a previous event matching the newly created event (e.g., the type or instance of the event has previously occurred at either a different time or location), traffic prediction program 112 bases the traffic impact for the new event on recorded traffic for the previous event. In other embodiments, traffic prediction program 112 retrieves data describing the event from external sources (not shown). For example, a message is posted describing a football game at a particular stadium. Traffic prediction program 112 retrieves the venue's capacity (e.g., the number of seats of the stadium) from a website of the stadium to determine the amount of traffic that will occur when the game ends. As another example, a message is posted regarding the end of a concert. Traffic predication program 112 retrieves the number of tickets sold from a ticketing service to determine the amount of traffic that will occur when the concert ends.

Referring back to process 208, if traffic prediction program 112 determines an event described in message data 132 or article data 142 is already present in event data 116 (YES branch of process 208), then traffic prediction program 112 combines the content and metadata of the message or article with the event in event data 116. In some embodiments, traffic prediction program 112 assigns a confidence score to an event. As more messages or articles describing the same event are determined, traffic prediction program 112 increases the confidence score. In other embodiments, traffic prediction program 112 determines the timing of a traffic event when combining messages or articles with event data 116. Referring back to the expo example discussed above, traffic prediction program 112 also retrieves a press release from article data 142 describing the expo. Traffic prediction program 112 determines the content of the press release includes the time the expo ends. Based on the time the arrival message was posted and the time indicated in the press release, traffic prediction program 112 determines the timing of the expo event.

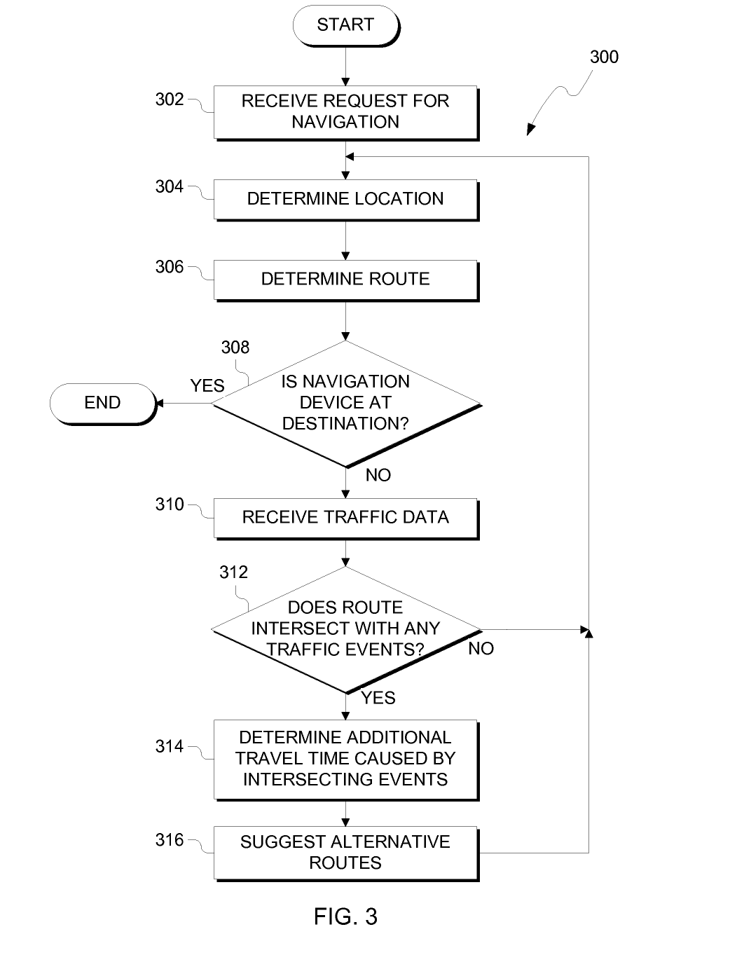

FIG. 3 illustrates operational processes, generally designated 300, of navigation program 124, on navigation device 120 within the environment of FIG. 1, in accordance with an exemplary embodiment of the present invention.

In process 302, navigation program 124 receives a request for navigation from a user including a destination. Navigation program 124 determines the location of the destination within the road network. In process 304, navigation program 124 determines the location of the navigation device 120. Navigation program 124 requests the current location from position system 122. In process 306, navigation program 124 determines a route for the user to take to get from the current location of navigation device 120 to the received destination in process 302. In some embodiments, navigation program 124 selects a route with the shortest travel time between the current location and the destination. In other embodiments, navigation program 124 includes other criteria when determining a route. For example, other criteria includes, but is not limited to, avoiding toll roads or staying on major roads (e.g., interstates or highways). In process 308, navigation program 124 determines if navigation device 120 has arrived at the destination. Navigation program 124 compares the current location of navigation device 120 to the destination location. Once both the current location of the navigation device and the destination are within a certain distance (e.g., 100 feet), then navigation program 124 ends providing the navigation route to the destination (YES branch of process 308). If navigation device 120 is not at the destination (NO branch of process 308), navigation program 124 displays the determined route in process 306 on a display of navigation device 120 and proceeds to process 310.

In process 310, navigation program 124 receives traffic data 114 from traffic prediction device 110. Traffic data 114 includes the current traffic for roads of the road network and the traffic impacts of events in event data 116. In process 312, navigation program 124 determines if the current route determined in process 306 intersects with the traffic caused by events in event data 116. Navigation program 124 determines a predicted time navigation device 110 will be along the current route to the destination. For example, based on known speed limits or current traffic, navigation program 112 determines the travel time along the current route and the time the navigation device 110 will based traveling with at the known speed limits of the routes for the route. Navigation program 124 compares the determined time and location along the route to traffic data 114 for the time and location. If the current route does not intersect with any traffic events in traffic data 114 (NO branch of process 312), then navigation program 124 determines a new current location of navigation device 120 (process 304). If the current route does intersect with one or more traffic events in traffic data 114 (YES branch of process 312), then navigation program 124 determines the additional travel time caused by the intersecting events (process 314).

In process 314, navigation program 124 determines the additional travel time caused by intersecting events with the current navigation route. Traffic data 114 includes the traffic impact of events for various roads or road segments in the road network. For single events that do not overlap either in time and location, traffic prediction program 112 includes an additional travel time caused or predicted to be caused by events for affected roads or road segments. For multiple events that overlap a location at one or more points in time, traffic prediction program 112 combines the additional travel time caused or predicted to be caused by the multitude of events. As discussed herein, in some embodiments, traffic prediction program 112 adds the additional time caused or predicted to be caused by the intersecting events. In other embodiments, traffic prediction program 112 applies an adjustment factor to the combined time, based on either a historic or statistical analysis. In various embodiments, navigation program 124 determines the total additional travel time for all intersecting events. In additional embodiments, navigation program 124 retrieves additional information from event data 116 including the impact area of traffic events for display on navigation device 120.

In process 316, navigation program 124 suggests alternative routes that shorten the additional travel time caused by the intersecting traffic events with the current route determined in process 306. For example, navigation program 124 sets a first waypoint on the current route prior to entering an area with one or more traffic events and a second waypoint exiting the traffic event, where the second waypoint is located close to either a position on the current route or the destination of the route. The first and second waypoints create points to bypass the traffic caused by the event, and, if used, would remove the portion of the current route where traffic events are occurring or will occur. Navigation program 124 determines one or more alternative routes using the first and second waypoints as starting and ending positions.

In some embodiments, navigation program 124 selects one or more of the alternative routes and suggests the selected alternative routes to the user. Navigation program 124 selects an alternative route for suggestion based on the travel time of the alternative route being less than the travel time of the bypassed portion of the current route. In addition, navigation program 124 determines any additional travel time for the alternative route caused by traffic events, using the processes discussed here with regards to the current route. Navigation program 124 presents the selected alternative routes to a user, including the time saved (i.e., the difference between travel times between each alternative route and the portion of the current route that is bypassed). Navigation program 124 receives a selection from the user and updates the current route to the destination. Navigation program 124 removes the bypassed portion and inserts the selected alternative route upon selection in process 306. Navigation program 124 updates the current location in process 304 and continually updates the current route with any selected alternative routes, as the navigation device 120 proceeds in the road network. Navigation program 124 continually receives traffic data 114 and determines and alternative routes until navigation device arrives at the destination location (YES branch of process 308).

In an embodiment, navigation program 124 automatically selects an alternative route for use without input from a user of navigation device 120. Navigation program 124 selects the alternative route with the greatest difference in travel time between one or more alternative route compared to the respective bypassed portion of the current route. In some embodiments, navigation program 124 does not suggest or automatically select any alternative routes. For example, if an alternative route does not provide a shorter travel time than the potentially bypassed portion of the current route, then navigation program 124 does not make the suggestion of automatically suggest the alternative route.

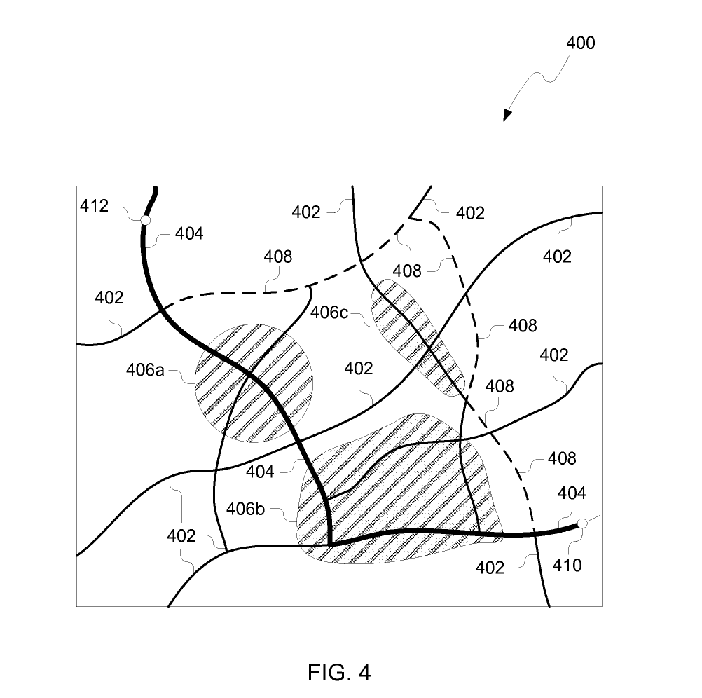

FIG. 4 illustrates example road network, 400, with current route 404, predicted traffic 406 and alternative route 408, in accordance with an exemplary embodiment of the present invention.

In various embodiments, road network 400 is displayed on navigation device 120 to a user with a current route to a destination. Road network 400 includes a view of road segments 402. Road segments 402 include potential roads that a navigation program 124 consider potential paths to a route to a destination. In this example display of road network 400, navigation program 124 does not display all road segments 402 of road network 400. Based on the current view (e.g., zoom factor or area within the view), navigation program 124 does not display all roads or segments of roads that serve as potential path for current route 404. Destination 410 is the received location from a user requested for navigation. Current location 412 is the current location of the navigation device 120 executing navigation program 124 and is the current location of the user of navigation device 120. Upon receiving destination 410, navigation program 112 determines current route 404, connecting current position 412 to destination 410. In this example, navigation program 112 determines current route 404 based on the smallest distance traveled using road segments 402 of road network 400.

In various embodiments, navigation program 124 receives traffic data 114. As discussed herein, navigation program 124 determines if current route 404 intersects with any traffic caused by or predicted to be caused by events stored in event data 116. Traffic events 406a, 406b and 406c represent the area of traffic impact three separate events are currently having or predicted to have on traffic within road segments 402. Navigation program 124 determines traffic events 406a and 406b intersect with current route 404. Based on the determined intersection with current route 404 and traffic events 406a and 406b, navigation program 124 determines alternate route 408 to bypass the traffic. Navigation program 124 determines one or more alternate routes which bypass traffic events 406a and 406b. The alternate routes includes any road segment 402 of road network 400, regardless of display by navigation device 120. In this example, navigation program 124 determines potential routes and automatically selects alternative route 408 for the user of navigation device 120 to travel. In the selection of alternative route 408, navigation program 124 determines a potential alternative route (not shown) that intersects with traffic event 406c. Navigation program 124 modifies the potential alternative route to bypass the area covered by traffic event 406c, thereby creating alternative route 408. Alternative route 408 is merged with current route 404 so that the user avoids the traffic caused by event indicated by traffic events 406a-c to arrive at destination 410.

FIG. 5 depicts a block diagram, 500, of components for each of traffic predicting device 110, navigation device 120, social media servers 130 and news servers 140, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Traffic predicting device 110, navigation device 120, social media servers 130 and news servers 140 each include communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Traffic predication program 112, traffic data 114, event data 116, positioning system 122, navigation program 124, message data 132 and article data 142 are each stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices, including resources of network 150. In these examples, communications unit 510 includes one or more network interface cards. Communications unit 510 may provide communications through the use of either or both physical and wireless communications links. Traffic predication program 112, traffic data 114, event data 116, positioning system 122, navigation program 124, message data 132 and article data 142 may each be downloaded to persistent storage 508 through communications unit 510.

I/O interface(s) 512 allows for input and output of data with other devices that may be connected to each of traffic predicting device 110, navigation device 120, social media servers 130 and news servers 140. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., Traffic predication program 112, traffic data 114, event data 116, positioning system 122, navigation program 124, message data 132 and article data 142, can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor, or a television screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) “Smalltalk” and the like may be subject to trademark rights in various jurisdictions throughout the world and are used here only in reference to the products or services properly denominated by the marks to the extent that such trademark rights may exist.

What is claimed is:

1. A method of predicting traffic, the method comprising:
determining, by one or more processors, a content of a first message posted to a social network;
determining, by the one or more processors, that the content of the first message describes a first event;
determining, by the one or more processors, an amount of predicted traffic to be caused by the first event;
determining, by the one or more processors, a content of a second message posted to a social network;
determining, by the one or more processors, that the content of the second message describes the first event; and
adjusting, by the one or more processors, the amount of predicted traffic to be caused by the first event based, at least in part, on the content of the first and second message.

2. The method of claim 1, wherein the first message indicates one or more of (i) a type of the first event, (ii) a location of the first event, and (iii) a time frame that first event will occur.

3. The method of claim 1, the method further comprising:
receiving, by the one or more processors, an observed amount of traffic caused by the first event;
determining, by the one or more processors, a difference between (i) the amount of predicted traffic to be caused by the first event and (ii) the observed amount of traffic caused by the first event; and
in response to the difference being above a certain amount of traffic, adjusting, by the one or more processors, an amount of predicted traffic to be caused by a second event, wherein the second event occurs at a later time than the first event.

4. The method of claim 1, wherein the amount of predicted traffic to be caused by the first event is increased based, at least in part, on the first and second message describing the first event.

5. The method of claim 1, the method further comprising:
determining, by the one or more processors, a content of an article posted to a news server;
determining, by the one or more processors, that the content of the article describes the first event; and
adjusting, by the one or more processors, the amount of predicted traffic to be caused by the first event based, at least in part, on the content of the first message and the article.

6. The method of claim 2, the method further comprising:
receiving, by the one or more processors, a location as a destination to for navigation;
determining, by the one or more processors, a route from a current location to the destination;
determining, by the one or more processors, a portion of the route intersects with a location of the first event; and
determining, by the one or more processors, a first alternative route which bypasses the portion of the route intersecting with the location of the first event.

7. The method of claim 6, the method further comprising:
determining, by the one or more processors, a content of a second message posted to a social network;
determining, by the one or more processors, the content of the second message describes a second event;
determining, by the one or more processors, a portion of the first alternative route intersects with a location of the first and second event; and
determining, by the one or more processors, a second alternative route which bypasses the portion of the route intersecting with the location of the first event and the portion of the first alternative route intersecting with the location of the second event.

8. A computer program product for predicting traffic, the computer program product comprising:
one or more computer-readable storage media and program instructions stored on the one or more computer-readable storage media, the program instructions comprising:
program instructions to determine a content of a first message posted to a social network;
program instructions to determine that the content of the first message describes a first event;
program instructions to determine an amount of predicted traffic to be caused by the first event;
program instructions to determine a content of a second message posted to a social network;
program instructions to determine that the content of the second message describes the first event; and
program instructions to adjust the amount of predicted traffic to be caused by the first event based, at least in part, on the content of the first and second message.

9. The computer program product of claim 8, wherein the first message indicates one or more of (i) a type of the first event, (ii) a location of the first event, and (iii) a time frame that first event will occur.

10. The computer program product of claim 8, the program instructions further comprising:
program instructions to receive an observed amount of traffic caused by the first event;
program instructions to determine a difference between (i) the amount of predicted traffic to be caused by the first event and (ii) the observed amount of traffic caused by the first event; and
program instructions to, in response to the difference being above a certain amount of traffic, adjust an amount of predicted traffic to be caused by a second event, wherein the second event occurs at a later time than the first event.

11. The computer program product of claim 8, wherein the amount of predicted traffic to be caused by the first event is increased based, at least in part, on the first and second message describing the first event.

12. The computer program product of claim 8, the program instructions further comprising:
program instructions to determine a content of an article posted to a news server;
program instructions to determine that the content of the article describes the first event; and
program instructions to adjust the amount of predicted traffic to be caused by the first event based, at least in part, on the content of the first message and the article.

13. The computer program product of claim 9, the program instructions further comprising:
program instructions to receive a location as a destination to for navigation;
program instructions to determine a route from a current location to the destination;
program instructions to determine a portion of the route intersects with a location of the first event; and
program instructions to determine a first alternative route which bypasses the portion of the route intersecting with the location of the first event.

14. The computer program product of claim 13, the program instructions further comprising:
program instructions determine a content of a second message posted to a social network;
program instructions determine the content of the second message describes a second event;
program instructions determine a portion of the first alternative route intersects with a location of the first and second event; and
program instructions determine a second alternative route which bypasses the portion of the route intersecting with the location of the first event and the portion of the first alternative route intersecting with the location of the second event.

15. A computer system for predicting traffic, the computer system comprising:
one or more computer processors;
one or more computer readable storage media; and
program instructions stored on the computer readable storage media for execution by at least one of the one or more processors, the program instructions comprising:
program instructions to determine a content of a first message posted to a social network;
program instructions to determine that the content of the first message describes a first event;
program instructions to determine an amount of predicted traffic to be caused by the first event;
program instructions to determine a content of a second message posted to a social network;
program instructions to determine that the content of the second message describes the first event; and
program instructions to adjust the amount of predicted traffic to be caused by the first event based, at least in part, on the content of the first and second message.

16. The computer system of claim 15, wherein the first message indicates one or more of (i) a type of the first event, (ii) a location of the first event, and (iii) a time frame that first event will occur.

17. The computer system of claim 15, the program instructions further comprising:
program instructions to receive an observed amount of traffic caused by the first event;
program instructions to determine a difference between (i) the amount of predicted traffic to be caused by the first event and (ii) the observed amount of traffic caused by the first event; and
program instructions to, in response to the difference being above a certain amount of traffic, adjust an amount of predicted traffic to be caused by a second event, wherein the second event occurs at a later time than the first event.

18. The computer system of claim 15, wherein the amount of predicted traffic to be caused by the first event is increased based, at least in part, on the first and second message describing the first event.

19. The computer system of claim 15, the program instructions further comprising:
program instructions to determine a content of an article posted to a news server;
program instructions to determine that the content of the article describes the first event; and
program instructions to adjust the amount of predicted traffic to be caused by the first event based, at least in part, on the content of the first message and the article.

20. The computer system of claim 16, the program instructions further comprising:
program instructions to receive a location as a destination to for navigation;
program instructions to determine a route from a current location to the destination;
program instructions to determine a portion of the route intersects with a location of the first event; and
program instructions to determine a first alternative route which bypasses the portion of the route intersecting with the location of the first event.
